(19) United States
(12) Patent Application Publication
(10) Pub. No.: US 2006/0202053 A1
(43) Pub. Date: Sep. 14, 2006

(54) Control valve assembly and fuel injector using same

(76) Inventors: Dennis H. Gibson, Chillicothe, IL (US); Mark F. Sommars, Sparland, IL (US)

Correspondence Address: Michael B. McNeil;Liell & McNeil Attorneys PC, P.O. Box 2417, Bloomington, IN, 47402, US

(21) Appl. No.: 11/076,275

(22) Filed: Mar. 9, 2005

(51) Int. Cl. F02M 47/02; F02M 51/00

(52) U.S. Cl. 239/88; 239/585.1

(57) ABSTRACT

The present disclosure provides a control valve assembly having at least one housing with a first and a second passage. First and second valve members are disposed at least partially within the housing, and in series. The first and second valve members are moveable between a first position to close fluid communications between the first and second passages and a second position to open fluid communications therebetween. The present disclosure further provides a fuel injector having an electronically controlled start of injection valve and an electronically controlled end of injection valve in series with the start of injection valve. A method is provided for controlling fluid flow in a fluid passage of a control valve assembly. The method includes commanding a change in position of a first electrically actuated valve member, and commanding the change in position of a second electrically actuated valve member prior to resetting the first electrically actuated valve member.

### TECHNICAL FIELD

The present disclosure relates generally to control valves and methods for controlling fluid flow between two or more fluid passages, and relates more particularly to a control valve assembly with a pair of valves disposed in series.

### BACKGROUND

A vast array of control valve designs and operating methods are known. In recent decades, the incorporation of relatively sophisticated control valve assemblies into internal combustion engine fuel systems has become commonplace. Control valves are employed, for example, in various aspects of fuel delivery, pressurization and injection in many internal combustion engines. Despite improvements in control valve assembly design and operation over the years, increasingly stringent government regulations for emissions and fuel economy continue to drive the search for improvements.

In an attempt to meet elevated performance and efficiency standards, engineers have continued to refine the precision with which control valves in internal combustion engines control the initiation, duration and termination of fuel injection events. For example, it has been found that relatively small pilot injections prior to a main injection, as well as relatively small post injections can in some instances improve the emissions quality and fuel economy of many engines. Multiple small, closely coupled injections are also used in certain applications. In one conventional design, a control valve controls fluid flow in a fuel injector body to adjust an admission valve between open and closed positions. With diminishing fuel injection quantities it can be necessary for the control valve to move relatively rapidly. In some systems, the upper limits of how fast the single control valve can be practicably adjusted to alter fluid flow have been approached. Higher injection pressures are also often employed, creating further challenges to increasing precision while decreasing injection quantity. It has become clear, however, that for certain applications even smaller and more precisely controlled injection quantities than are available in conventional systems may be desirable.

In an attempt to improve the responsiveness of certain fuel injector control valve assemblies, many manufacturers have begun to explore piezoelectric actuators rather than traditional solenoid-operated electrical actuators in their control valve assemblies. Piezoelectric actuators tend to offer a faster response time to a control signal than certain solenoid operated actuators. This is due at least in part to the time it takes to energize and de-energize a solenoid coil, and also the time it takes for a valve member to traverse a travel distance. Piezoelectric actuators employ piezoelectric materials which can change conformation rapidly when an electric field is applied to them, and in turn control the motion of a valve member relatively rapidly, obviating some of the concerns respecting solenoid operated assemblies.

While piezoelectric actuators have shown promise, implementation may be expensive and require design changes to existing fuel systems. To avoid these concerns, some fuel injection apparatus manufacturers have attempted to build upon existing technologies in solenoid operated control valve assemblies. One such development is described in United States Patent Application Publication No. U.S. 2003/0102391 to Rodriguez-Amaya et al., entitled Electro Magnetic Valve-Actuated Control Module For Controlling Fluid In Injection Systems. Rodriguez-Amaya et al. describe a control module for fluid control in injection systems, that includes a valve body in which needle control valves are positioned. The needle control valves are used to vary pressure build-up or pressure relief in control chambers or nozzle chambers of a fuel injector. Although the design of Rodriguez-Amaya et al. may have certain applications, there is always room for improvement.

The present disclosure is directed to one or more of the problems or shortcomings set forth above.

### SUMMARY OF THE DISCLOSURE

In one aspect, the present disclosure provides a control valve assembly. The control valve assembly includes at least one housing, having a first passage and a second passage. A first valve member that is coupled with a first electrical actuator is disposed at least partially within the at least one housing, and is moveable between a first position and a second position to close and open fluid communications, respectively between the first and second passages. A second valve member is also positioned at least partially within the at least one housing, and is coupled with a second electrical actuator. The second valve member is positioned in series with the first valve member, and is movable between a first position and a second position to close and open fluid communications, respectively, between the first and second passages.

In another aspect, the present disclosure provides a fuel injector. The fuel injector includes an electronically controlled start of injection valve moveable between first and second positions, and an electronically controlled end of injection valve disposed in series with the start of injection valve and movable between first and second positions.

In still another aspect, the present disclosure provides a method of controlling fluid flow in a fluid passage of a control valve assembly. The method includes the step of commanding a change in position of a first electrically actuated valve to move a first valve member disposed at least partially within the fluid passage from a first position to a second position. The method further includes the step of, prior to returning the first valve member to its first position, commanding a change in position of a second electrically actuated valve to move a second valve member disposed in series with the first valve member from a first position to a second position.

### BRIEF DESCRIPTION OF THE DRAWINGS

FIG. 1 is a schematic illustration of a fuel injector and a control valve assembly according to the present disclosure;

FIG. 2 is a schematic illustration of a fuel injector and control valve assembly according to another embodiment of the present disclosure;

FIG. 3 is a schematic illustration of a fuel injector and control valve assembly according to yet another embodiment of the present disclosure;

FIG. 4 is a graph illustrating operation of a fuel injection system according to the present disclosure in comparison with a known fuel injection system.

### DETAILED DESCRIPTION

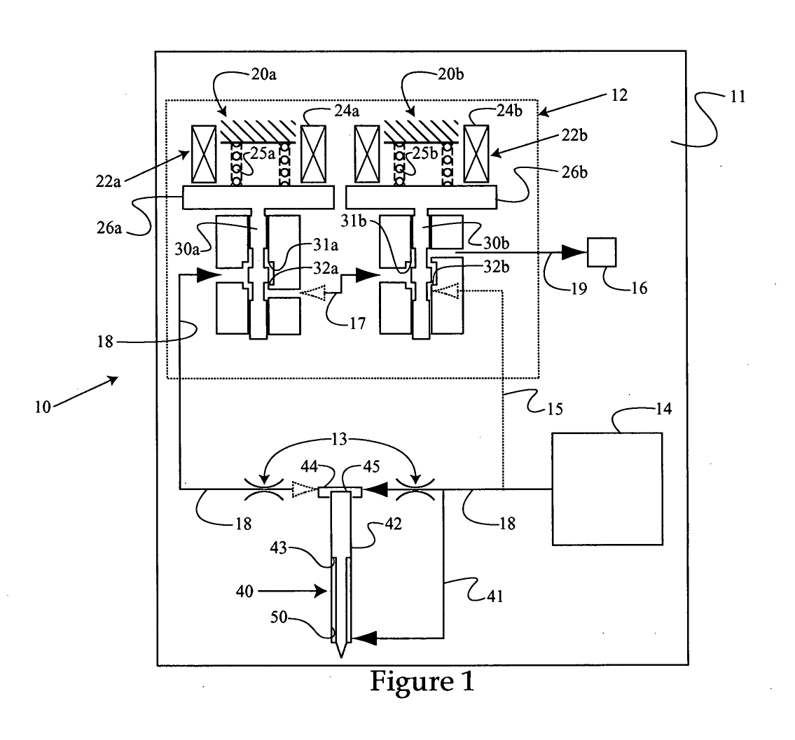

Referring to FIG. 1, there is shown schematically a fuel injector 10 having a control valve assembly 12, according to one embodiment of the present disclosure. Control valve assembly 12 includes a first valve, or start of injection valve 20a, and a second valve, or end of injection valve 20b. Valves 20a and 20b each include a movable valve member 30a and 30b, respectively, that is positioned at least partially within a housing 1. Valve members 30a and 30b are disposed in series in housing 11. Start of injection valve 20a may be operable to control an initiation of fuel injection to an engine cylinder (not shown) via an admission valve 40, whereas end of injection valve 20b may be operable to control the end of an injection via admission valve 40. Control of the state or position of admission valve 40 according to the present disclosure will allow relatively small fuel injection quantities, and relatively precise control over initiation and termination of a particular fuel injection event, as described herein. While it is contemplated that one application of control valve assembly 12 will be in fuel injection systems, those skilled in the art will appreciate that control valve assembly 12 may be applicable in areas unrelated to fuel systems.

While control valve assembly 12 is shown in a single housing 11 with other components of fuel injector 10, it should be appreciated that more than one housing might be used in constructing control valve assembly 12, or fuel injector 10 generally. Admission valve 40 may be a direct control admission valve or direct operated check whose position is controlled at least in part with valves 20a and 20b, however, it should be appreciated that alternative fuel injector embodiments are contemplated. For instance, rather than an admission valve, designs are contemplated wherein valves 20a and 20b control fluid pressure supplied to the pressure surface of an intensifier piston within a fuel injector.

A related contemplated embodiment may include control of a fuel pressurization mechanism independent from injector 10. In such an embodiment, control valve assembly 12 may be operably coupled with a fuel pressurization plunger. In such an embodiment, when fuel pressurization is desired control valve assembly may be operated similar to the manner described herein to supply pressurized fluid to a pressure surface of the plunger. The plunger will be driven down by the pressurized fluid and will in turn pressurize a fuel chamber fluidly connected with an admission valve similar to that shown in FIG. 1.

Fuel injector 10 will typically be connected with a high pressure fluid source 14 and a low pressure drain 16. The high pressure fluid selected may be a fuel such as diesel or gasoline, however, alternative embodiments are contemplated wherein engine oil, transmission or coolant fluid or another suitable hydraulic fluid is used. High pressure fluid source 14 may be a common rail, but might also be a cam-operated fuel pressurizer, for example. High pressure fluid may be supplied to a control chamber 44 of admission valve 40, via a first fluid passage 18. Start of injection valve 20a may control fluid communications between first passage 18 and a second fluid passage 19, which may in turn be alternately connected or blocked from drain 16 with end of injection valve 20b. An intermediate passage 17 may connect first and second passages 18 and 19.

In the embodiment of FIG. 1, admission valve 40 includes a needle valve member 42 having a control surface 45 exposed to a fluid pressure from first passage 18 in control chamber 44 and opening hydraulic surfaces 43 exposed to a fluid pressure in a nozzle chamber 50. Control surface 45 will typically be sized such that hydraulic force thereon will bias needle valve member 42 toward a seated position between injection events, as described herein. Fluid pressure in chamber 44 may be varied via valves 20a and 20b to move needle valve member 42 away from a seat (not shown), and thereby open nozzle chamber 50 to inject pressurized fuel. To this end, needle valve member 42 will typically include opening hydraulic surfaces 43 exposed to nozzle chamber 50. Control surface 45 and opening hydraulic surfaces 43 will typically be sized such that when pressure in chamber 44 is reduced, as described herein, sufficient hydraulic pressure will exist in nozzle chamber 50 to lift valve member 42 from a seated position.

When nozzle chamber 50 is opened by retraction of valve member 42, pressurized fuel from high pressure fluid source 14 may flow from first passage 18 through a nozzle passage 41 and out nozzle chamber 50. While the embodiment of FIG. 1 includes nozzle passage 41, it should be appreciated that alternative embodiments are contemplated wherein control valve assembly 12 is used to directly control admission valve 40, but a separate fluid delivery system is used to supply pressurized fuel to nozzle chamber 50. Flow restrictions 13 may be positioned on opposite sides of control chamber 44 to limit fluid flow in a manner well known in the art. In one contemplated embodiment, a drain side of passage 18, connecting control chamber 44 with start of injection valve 20a, will be slightly larger than the opposite side, connecting control chamber 44 with high pressure fluid source 14.

Turning in particular to control valve assembly 12, each of start of injection valve 20a and end of injection valve 20b will typically be electrically actuated. Start of injection valve 20a may include a first electrical actuator 22a, whereas end of injection valve 20b may include a second electrical actuator 22b. Control valve assembly 12 will typically be coupled with an electronic controller having separate solenoid drivers for each of electrical actuators 22a and 22b. It is contemplated that first and second electrical actuators 22a and 22b will typically be solenoid driven electrical actuators, although an alternative type of electrical actuator such as a piezoelectric actuator might be used if desired. Thus, first electrical actuator 22a may include a first solenoid 22a and first armature 26a coupled to move with first valve member 30a, whereas second electrical actuator 22b may include a second solenoid 24b and a second armature 26b coupled to move with second valve member 30b.

Each of first and second armatures 26a and 26b will typically be biased with a respective first biasing spring 25a and second biasing spring 25b. Each of biasing springs 25a and 25b will typically bias valve members 30a and 30b, respectively, towards one of a first position at which the respective valve member will close fluid communications between first and second passages 18 and 19, and a second position at which the respective valve member will not block fluid communications between passages 18 and 19. In the embodiment of FIG. 1, biasing springs 25a and 25b bias the first valve member 30a and second valve member 30b toward first and second positions, respectively. It should be appreciated that descriptions herein of “first” and “second” positions should not be understood to limit the disclosure. In other words, the terms are for convenience of description and either of the described positions of the respective valve members might be considered either of a first or a second position.

First valve member 30a may be movably trapped between a stop 31a and a first seat 32a. Energizing first electrical actuator 22a will cause armature 26a to move toward solenoid coil 24a, against the force of spring 25a.

Armature 26a is coupled to move with first valve member 30a and will thus move the same from its first position against seat 32a, blocking fluid communications between passages 18 and 19, to its second position against stop 31a and allowing fluid flow past seat 32a.

Second valve member 30b may be movably trapped between a second seat 31b and one of, a third seat and a stop 32b. Second valve member 30b will typically be biased toward its second position, shown in FIG. 1, at which fluid may flow past second seat 31b. Thus, when first valve member 30a is moved from first seat 31a, fluid communications will be established between first passage 18 and second passage 19, in turn connecting chamber 44 with drain 16. Activation of first electrical actuator 20a may thereby induce a pressure drop in chamber 44 by fluidly connecting chamber 44 with drain 16, allowing needle valve member 42 to retract under hydraulic force in chamber 50 and open the same to inject fuel.

As described, housing 11 may include either of a third seat or a stop 32b, against which second valve member 30b rests in its second, biased position. Activation of second electrical actuator 20b may cause armature 26b to move toward second solenoid coil 24b against the biasing force of second spring 25b, and in turn move second valve member 30b toward second seat 31b. When second valve member 30b reaches second seat 31b, fluid communications will be blocked between first and second passages 18 and 19, and consequently between chamber 44 and drain 16. Blocking said fluid communications will allow hydraulic pressure in chamber 44 to rise, bearing against control surface 45 and closing chamber 50 with needle valve member 42 to terminate fuel injection.

In an embodiment wherein housing 11 includes a third seat 32b, a third passage 15 may connect seat 32b with first passage 18 and high pressure fluid source 14. By way of its connection with first passage 18 and high pressure fluid source 14, passage 15 may provide a hydraulic pressure that will make it relatively easier and faster to move second valve member 30b to its first position, blocking fluid communications between first and second passages 18 and 19. In addition, because chamber 44 will typically be exposed to high pressure from passage 18, when second valve member 30b moves from third seat 32b, high pressure will be supplied to chamber 44 from two directions. This may allow the pressure therein to build relatively more rapidly and decrease the time required to move valve member 42 to close nozzle chamber 50 and terminate injection. The directions of the solid black arrows in the fluid passages of fuel injector 10 represent an initial and typical fluid flow direction when start of injection valve 20a first opens fluid communications between first passage 18 and second passage 19. Dashed arrows represent a reverse fluid flow in an embodiment utilizing third passage 15, occurring when second valve member 30b is moved from third seat 32b.

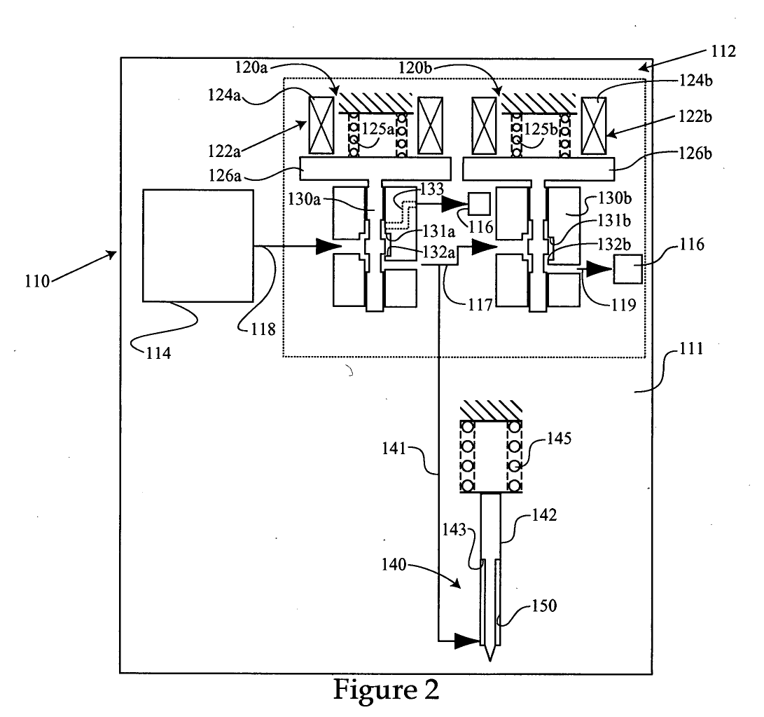

Referring to FIG. 2, there is shown a fuel injector 110 according to another embodiment of the present disclosure. Fuel injector 110 may include one or more housings 111, and a control valve assembly 112. Similar to the embodiment of FIG. 1, control valve assembly 112 includes a start of injection valve 120a, an end of injection valve 120b and an admission valve 140. Start of injection valve 120a may include a first electrical actuator 122 having a solenoid 124a, an armature 126a and a biasing spring 125a. Start of injection valve 120a may further be coupled with a first valve member 130a movable between a first and a second position. In a first position, shown in FIG. 2, first valve member 130a may be adjacent a first seat 132a, blocking fluid communications between a first passage 118 and a second passage 119, connected by an intermediate passage 117. Fluid communications will exist, however, between first passage 118 and a third passage 133, in turn connecting with a drain 116. A high pressure fluid source 114 is connected with first passage 118 and, accordingly, pressurized fluid may continuously flow or “spill” from source 114 via passage 118 to passage 133, and thenceforth to drain 116 when first valve member 130b is in its first position. As in the foregoing embodiment, high pressure fluid source may be a common rail, or a cam-operated pressurization mechanism such as are known in the art. In a second position, first valve member 130a will be against another seat 131a, at which it may block fluid communications between first passage 118 and third passage 133, but permit fluid flow between first passage 118 and intermediate passage 117. Thus, start of injection valve 120a operates similarly to the embodiment of FIG. 1 in that it will open fluid communications between two passages, controlling a fluid pressure to admission valve 140 to initiate injection, as described herein. Fuel injector 110 differs from injector 10 of FIG. 1, among other things, in that admission valve 140 is not directly controlled.

End of injection valve 120b is similar in design to start of injection valve 120a. End of injection valve 120b may include a second electrical actuator 120b that includes a solenoid 124b, an armature 126b and a biasing spring 125b. A second valve member 130b is coupled to move with armature 126b, and may be movable between a stop 131b and a seat 132b. Biasing spring 125b will typically bias armature 126b and second valve member 130b toward a first position, shown in FIG. 2, at which second valve member 132b is adjacent seat 132b, and blocks fluid communications between second passage 118 and first passage 119.

A nozzle passage 141 fluidly connects intermediate passage 117 with a nozzle chamber 150. Admission valve 140 may include an admission valve member, for example, a needle valve member 142 disposed in housing 111 and having opening hydraulic surfaces 143. Needle valve member 142 may be movable to alternately block nozzle chamber 150 or open the same to permit fuel injection into an associated engine cylinder (not shown). A biasing spring 145 will typically be provided to bias needle valve member 142 toward a closed position.

Between injection events, nozzle passage 141 will typically be blocked from fluid communication with either of passages 118 or 119. Upon activation of first electrical actuator 120a, first valve member 130a will typically be moved toward its second position to establish fluid communications between nozzle passage 141 and first passage 118. Pressurized fluid can then flow via passage 118 to nozzle chamber 150, urging needle valve member 142 toward an open position to allow fuel to be injected from chamber 150. Activation of second electrical actuator 120b will typically move second valve member 130b toward its second position, opening fluid communications between nozzle passage 141 and drain 116 via intermediate passage 117. When nozzle passage 141 is fluidly connected with drain 116, pressure will drop in nozzle chamber 150 and biasing spring 145 will urge needle valve member 142 to a closed position to terminate fuel injection.

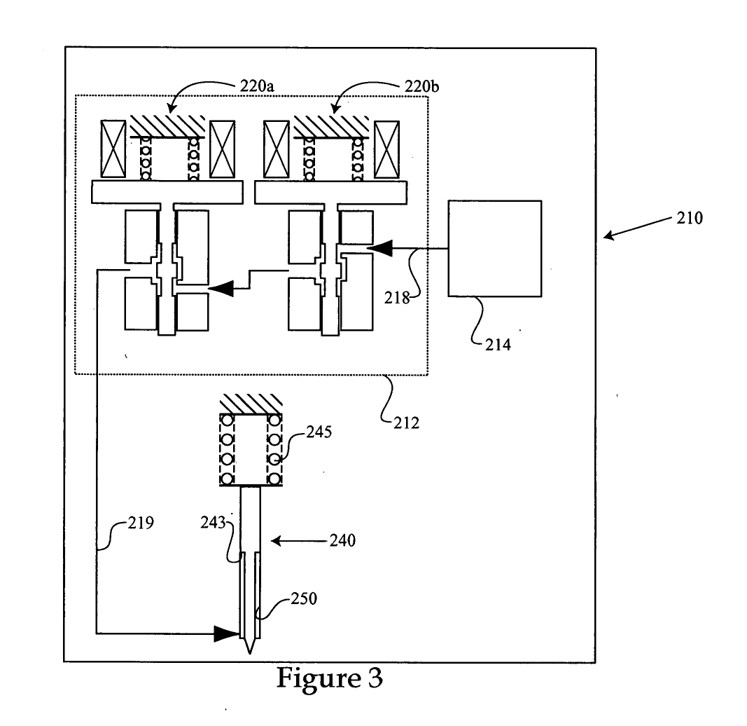

Turning to FIG. 3, there is shown a fuel injector 210 and control valve assembly 212 according to yet another embodiment of the present disclosure. Fuel injector 210 includes at least one housing 211, and is connected with a source of pressurized fuel 214. Control valve assembly 212 is operable to selectively connect a first passage 218 with a second passage 219. Second passage 219 is in turn fluidly connected with a nozzle chamber 250. An admission valve 240 is operable to open or close nozzle chamber 250.

Control valve assembly 212 includes a start of injection valve 220a and an end of injection valve 220b. Start of injection valve 220a will typically be operable to selectively connect first passage 218 with second passage 219. When start of injection valve 220a is actuated to open said fluid communications, high pressure fuel from source 214 will be supplied via passage 219 to nozzle chamber 250, raising the pressure therein sufficiently to lift admission valve 240 from a seated position via pressure on opening hydraulic surfaces 243. Actuation of end of injection valve 220b will conversely block fluid communications between first passage 218 and second passage 219, ending injection by blocking fluid communications between high pressure fuel source 214 and nozzle chamber 250 and allowing a biasing means 245 to return admission valve 240 to a seated position.

### INDUSTRIAL APPLICABILITY

Returning to FIG. 1, the components of fuel injector 10 are shown in the positions they would typically occupy just prior to initiation of an injection event. First and second electrical actuators 20a and 20b are de-energized, biasing springs 25a and 25b bias armatures 26a and 26b, respectively, away from solenoids 24a and 24b. First valve member 30a is in its first position, biased against seat 32a and blocking fluid communications between first passage 18 and second passage 19. Second valve member 30b is in its second position, biased against seat/stop 32b and permitting fluid communications between intermediate passage 17 and second passage 19. In an embodiment employing third passage 15, second valve member 30b will block fluid communications between third passage 15 and passages 17 and 19 at its second position. High pressure fuel from high pressure fluid source 14 is incident to chamber 44, biasing needle valve member 42 toward a closed position at which nozzle chamber 50 is blocked. High pressure fuel from high pressure fluid source 14 is also incident to nozzle chamber 50 from nozzle passage 41. Pressure surface 45 will typically be larger than opening hydraulic surfaces 43 of needle valve member 42 and, accordingly, the hydraulic force thereon from the pressurized fluid in chamber 44 will be sufficient to keep needle valve member 42 seated and block fuel from discharging from chamber 50.

Just prior to the desired time of initiation of a fuel injection event, a first control signal may be sent from a first solenoid driver of an electronic controller to first electrical actuator 20a. Electrical current in solenoid 24a will generate a magnetic field, drawing armature 26a toward solenoid 24a and moving first valve member 30a toward its second position, away from seat 32a and toward stop 31a. The opening of fluid communications between first passage 18 and second passage 19 will allow pressure in chamber 44 to drop. High pressure fuel continues to be supplied to nozzle chamber 41 and, when pressure in chamber 44 has dropped sufficiently, needle valve member 42 will move away from its seated position to allow fuel to be injected to the associated engine cylinder.

Prior to the point in time at which termination of the fuel injection event is desired, a second control signal may be sent from a second solenoid driver of the electronic controller to second electrical actuator 20b. The second control signal will typically be sent prior to first valve member 30a returning to its deactivated position with biasing spring 25a. Activation of second electrical actuator 22b will cause second valve member 30b to move toward its first position against seat 31b, blocking fluid communications between first passage 18 and second passage 19. Shortly after second electrical actuator 22b is activated, pressure in chamber 44 may rise sufficiently such that needle valve member 42 will block nozzle chamber 50 and end the fuel injection event.

The length of certain fuel injection events may be of such short duration that the second control signal from the second solenoid driver to the second electrical actuator may partially overlap with the first control signal from the first solenoid driver to the first electrical actuator. The duration of an injection event may be adjusted by varying the amount of temporal overlap in the respective control signals sent to first and second electrical actuators 22a and 22b, respectively. In general terms, an increasing amount of overlap in the control signals will correlate with a shorter injection event, and shorter injection quantity. Those skilled in the art will appreciate that various factors may bear on the amount of signal overlap required to generate a fuel injection event having a particular duration or quantity. For instance, where the travel distance of the respective valve members 30a and 30b is relatively large, a relatively greater degree of control signal overlap may be required to inject a given fuel quantity, whereas with relatively smaller travel distances a lesser degree of control signal overlap may be required to inject the same amount of fuel.

Referring again to FIG. 2, fuel injector 110 and control valve assembly 112 are shown as they would appear just prior to initiation of an injection event. Fluid communications between first passage 118 and second passage 119 are blocked. Pressurized fuel from high pressure supply 114 is continually spilling to drain 116. Biasing spring 145 urges needle valve member 142 to a seated position at which it blocks nozzle chamber 150. When initiation of an injection event is desired, a control signal will be sent to first electrical actuator 120a to move first valve member 130a toward a second position, opening fluid communications between passage 118 and nozzle passage 141. Pressurized fuel from passage 141 will impinge upon opening hydraulic surfaces of needle valve member 142, overcoming the biasing force of spring 145 to urge needle valve member 142 away from its seated position and open nozzle chamber 150, allowing injection of fuel.

At an appropriate time, a control signal will be sent to second electrical actuator 120b to energize the same and move second valve member 130b away from seat 132b, establishing fluid communications between nozzle passage 141 and drain 116 via passages 117 and 118. Shortly after fluid communications are established between nozzle passage 141 and drain 116, hydraulic pressure in nozzle chamber 150 will drop and biasing spring 145 will return needle valve member 142 to a seated position, terminating injection. Similar concerns to those described with regard to the FIG. 1 embodiment will dictate timing and adjustment or overlapping of the respective control signals sent to electrical actuators 120a and 120b.

Turning again to FIG. 3, the components of fuel injector 210 and control valve assembly 212 are shown in positions they may occupy just prior to initiation of an injection event. Similar to the embodiments of FIGS. 1 and 2, a control signal will be sent to the electrical actuator of start of injection valve 220a to open fluid communications between passages 218 and 219, initiating injection. A second control signal will be sent to the electrical actuator of end of injection valve 220b to terminate injection. Variation in the temporal overlapping of the control signals may be utilized to vary the duration of the fuel injection event.

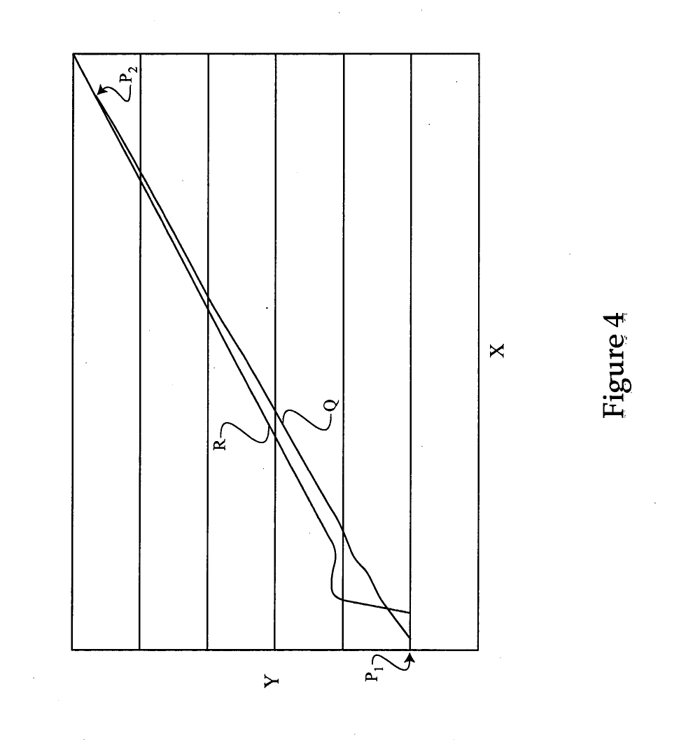

Referring to FIG. 4, there is shown a graph illustrating exemplary operation of a twin control valve assembly Q according to the present disclosure in comparison with a conventional single control valve assembly R. The Y axis represents percent injector delivery, whereas the X axis represents percent of injector on time. P₁ represents a zero point for axes X and Y. P₂ represents an approximate point at which the injector percent delivery and percent on time are approximately equal for twin control valve assembly Q and single control valve assembly R. It is contemplated that P₄ will lie at approximately 90% injector delivery, yielding approximately 90% on time performance.

As illustrated, assembly Q provides a relatively constant linear relationship between percent injector on time and percent injector delivery. In contrast, assembly R includes a non-linear portion, particularly toward the lower end of the range. The non-linearity of the behavior of R with relatively smaller injection quantities can make operation difficult to predict. Relatively small adjustments in the injection quantity can also have a significant effect on the percent at which the injector is on time. In contrast, a design having twin control valves, Q, is more linear and predictable. Moreover, where adjustment of the injection quantity is desired, the resultant change in percent injector on time will not typically be so large as in R. Those skilled in the art will further appreciate that Q will make available smaller injection quantity deliveries than R, as illustrated in FIG. 4. The availability of smaller injection quantities can allow engineers to further refine fuel injection strategies, particularly with regard to small pilot and post injections.

The present disclosure thus provides for more precise control and smaller fuel injection quantities than many earlier designs. Such operation also employs electromagnetic solenoid technologies, which are less expensive than other, more exotic technologies such as piezoelectric actuators. By overlapping the control signals from respective solenoid drivers, as described herein, the amount of time during which the pressure changes in a needle control chamber sufficiently to allow fuel injection can be in theory as small as the designer would like. Actuation delays related to generation and decay of solenoid magnetic fields, and the time required to move valves across a travel distance, however small, are also cancelled, a common problem in many earlier single valve designs.

Adjusting the injection quantity is possible by adjusting the degree of control signal temporal overlap, in all of the embodiments described herein. In addition, overlapping of the control signals allows more closely coupled injections than in many earlier designs. For example, actuation of end of injection valve 20b of the FIG. 1 embodiment may be commanded prior to resetting of start of injection valve 20a. In a like manner, a second actuation of start of injection valve 20a may be commanded prior to resetting end of injection valve 20b, via overlapping control signals. Therefore, initiation of a second injection event may take place a relatively short period of time after terminating a first injection event.

The present description is for illustrative purposes only, and should not be construed to narrow the scope of the present disclosure in any way. Thus, those skilled in the art will appreciate that various modifications might be made to the presently disclosed embodiments without departing from the intended spirit and scope of the present disclosure. For example, in other contemplated embodiments, high pressure fluid source 14 might be a variable pressure feed such that variable injection pressures and corresponding injection quantities are available. In still further contemplated embodiments, spool valves may be substituted for one or both of the described first and second valve members 30a and 30b. Other aspects, features and advantages will be apparent upon an examination of the attached drawing Figures and appended claims.

1. A control valve assembly comprising:
at least one housing including a first passage and a second passage;
a first valve member coupled with a first electrical actuator and disposed at least partially within said at least one housing, said first valve member being movable between a first position and a second position to close and open fluid communications, respectively, between said first and second passages; and
a second valve member coupled with a second electrical actuator and disposed at least partially within said at least one housing and in series with said first valve member, said second valve member being movable between a first position and a second position to close and open fluid communications, respectively, between said first and second passages.

2. The control valve assembly of claim 1 wherein:
said first electrical actuator includes a solenoid and an armature coupled to move with said first valve member; and
said second electrical actuator includes a solenoid and an armature coupled to move with said second valve member.

3. The control valve assembly of claim 2 wherein:
said first valve member is movably trapped between a first seat and a stop; and
said second valve member is movably trapped between a second seat and one of, a third seat and a stop.

4. The control valve assembly of claim 3 wherein:
said at least one housing includes a third passage; and
said second valve member is movably trapped between said second seat and a third seat, said second valve member blocking fluid communications between said third passage and said second passage when adjacent said third seat.

5. The control valve assembly of claim 4 wherein said third passage is in fluid communication with said first passage.

6. The control valve assembly of claim 3 further comprising:
a first biasing means biasing said first valve member toward its first position; and
a second biasing means biasing said second valve member toward its second position.

7. The control valve assembly of claim 6 further comprising:
an electrical system including a first solenoid driver operable to energize said first electrical actuator, and a second solenoid driver operable independently of said first solenoid driver to energize said second electrical actuator.

8. The control valve assembly of claim 7 further comprising a hydraulically reciprocable member disposed at least partially within said at least one housing and including a control surface exposed to a fluid pressure in one of said first and second fluid passages.

9. A fuel injector comprising:
an electronically controlled start of injection valve movable between first and second positions; and
an electronically controlled end of injection valve disposed in series with said start of injection valve and movable between first and second positions.

10. The fuel injector of claim 9 further comprising:
a first electrical actuator including a solenoid and an armature and operably coupled with said start of injection valve; and
a second electrical actuator including a solenoid and an armature and operably coupled with said end of injection valve.

11. The fuel injector of claim 10 further comprising:
a first fluid passage and a second fluid passage, said start of injection valve and said end of injection valve being operable to respectively open and close fluid communications between said first and second fluid passages; and
an admission valve member having a control surface exposed to a fluid pressure in one of said first and second passages, said admission valve member being movable to selectively open or close a fuel outlet of said fuel injector.

12. The fuel injector of claim 11 comprising a control chamber fluidly connected with said first passage, said admission valve control surface being exposed to said control chamber;
wherein said start of injection valve is operable to selectively connect said control chamber with said second passage, and said end of injection valve is operable to selectively block said control chamber from said second passage.

13. The fuel injector of claim 12 comprising:
a third passage connecting with said first passage; and
an intermediate passage fluidly connecting said start of injection valve and said end of injection valve, said end of injection valve selectively opening or closing fluid communications between said third passage and said intermediate passage.

14. The fuel injector of claim 12 wherein:
said start of injection valve includes a first valve member movably trapped between a first seat and a stop; and
said end of injection valve includes a second valve member movably trapped between a second seat and one of, a third seat and a stop;
said fuel injector including a first biasing means biasing said first valve member against said first seat; and
said fuel injector including a second biasing means biasing said second valve member away from said second seat.

15. The fuel injector of claim 13 comprising an electrical system having a first solenoid driver operable to energize the solenoid of said first electrical actuator, and a second solenoid driver operable to independently energize the solenoid of said second electrical actuator.

16. A method of controlling fluid flow in a fluid passage of a control valve assembly comprising the steps of:
commanding a change in position of a first electrically actuated valve to move a first valve member disposed at least partially within the fluid passage from a first position to a second position; and
prior to returning the first valve member to its first position, commanding a change in position of a second electrically actuated valve to move a second valve member disposed in series with the first valve member from a first position to a second position.

17. The method of claim 16 wherein:
a first of the commanding steps includes one of, lowering and raising pressure in a chamber; and
a second of the commanding steps includes the other of, lowering and raising pressure in a chamber.

18. The method of claim 17 wherein:
the step of commanding a change in position of the first electrically actuated valve comprises sending a first control signal to a first electrical actuator of the first electrically actuated valve; and
the step of commanding a change in position of the second electrically actuated valve comprises sending a second control signal which overlaps with the first control signal to a second electrical actuator of the second electrically actuated valve.

19. The method of claim 18 comprising the step of, adjusting a timing of at least one of, a start of injection and an end of injection by adjusting a temporal overlap in the first and second control signals.

20. The method of claim 19 wherein:
the chamber includes a needle control chamber and a nozzle chamber of a fuel injector;
the first commanding step includes relieving pressure on a closing hydraulic surface exposed in the needle control chamber and raising pressure on an opening hydraulic surface exposed to pressure in the nozzle chamber; and
the second commanding step includes increasing pressure on the closing hydraulic surface, and lowering pressure in the nozzle chamber.
